(19) United States
(12) Patent Application Publication
(10) Pub. No.: US 2019/0147418 A1
(43) Pub. Date: May 16, 2019

(54) MULTIBANK BIOMETRIC AUTHENTICATION SYSTEM APPLIED IN AUTOMATIC TELLER MACHINES EQUIPPED WITH BIOMETRIC SENSORS

(71) Applicant: TECNOLOGIA BANCARIA S.A., Barueri (BR)

(72) Inventors: Carlos Issao Kuribara, Barueri (BR); Rodrigo Paiva Inácio Lima, São Paulo City (BR); Elcio Seiji Tabuti, São Paulo City (BR); Fabiana Tiemi Oda Katanosaka, São Paulo City (BR); Simone Reboreda Simões, São Paulo City (BR)

(21) Appl. No.: 16/227,640

(22) Filed: Dec. 20, 2018

Related U.S. Application Data
(63) Continuation-in-part of application No. 16/032,631, filed on Jul. 11, 2018.
Application No. 16/032,631 is a continuation of application No. 14/697,852, filed on Apr. 28, 2015, now abandoned.

(30) Foreign Application Priority Data
Apr. 28, 2014 (BR) 10-2014-010137-3

(51) Int. Cl. G06Q 20/10; G06Q 20/40

(52) U.S. Cl. CPC G06Q 20/10; G06Q 20/1085; G06Q 20/40145; G06Q 20/40

(57) ABSTRACT

“Multibank Biometric Authentication System Applied In Automatic Teller Machines Equipped With Biometric Sensors”, more specifically, to the use of teller machines to perform transactions with biometric authentication with one, two or three sensors; the system proposed performed requiring only the requiring contingency devices, i.e., BIOMETRIC automatic multibank biometric be or positive identification, TAN CODE, TOKEN, or further, that it is realized requesting the combination of devices, being the referred solution developed to reduce costs and increase accuracy in the user (U) authentication, providing full security in financial transactions, on a configurable customized manner to attend the needs of the financial institutions (16) and users (U).

### CROSS-REFERENCE TO RELATED APPLICATIONS

This application is a Continuation-in-Part of U.S. patent application Ser. No. 16/032,631, filed on Jul. 11, 2018 and which is a continuation of U.S. patent application Ser. No. 14/697,852, filed on Apr. 28, 2015 both of which are hereby incorporated by reference in their entirety. This application claims the benefit of Brazilian Application No. 10-2014-010137-3, filed on Apr. 28, 2014 which is hereby incorporated by reference in its entirety.

### TECHNICAL FIELD

This specification relates to a patent application of invention that foresees a multibank biometric authentication system applied in automatic teller machines, which preferably has three biometric sensors.

### BACKGROUND OF THE ART

Nowadays, financial institutions are replacing their security solutions for bank account access through an automated teller machine (ATM), which occurs by entering personal passwords, security codes, personal information and other combinations of numerical, syllabic and similar information, which are generally entered by users upon accessing, via biometric authentication solutions.

Currently, on the financial institutions branch, there is no provision of a system that enables the biometric authentication of several banks in one ATM network used by such banks, where such biometric authentication can be based on at least three different sensors.

The applicant acts within the context described above, being a company that manages a network of multibank ATMs that are used by users of several financial institutions, where each one of it must preferably adopt three security solutions with biometric authentication.

The applicant, hereinafter referred to as Company “X” in this specification, after a long development period enabled the system to attend users of financial institutions adopting different biometric authentication solutions.

### SUMMARY OF THE INVENTION

The Company “X”, interested in providing improvements regarding security when using automatic teller machines, after countless researches and tests, created and developed this “MULTIBANK BIOMETRIC AUTHENTICATION SYSTEM APPLIED IN AUTOMATIC TELLER MACHINES WITH BIOMETRIC SENSORS”, which must be placed with highlights among its counterparts and personalized before the consumer market because it presents a multibank biometric authentication system preferably using three biometric sensors, system where financial institutions may choose to adopt one of the biometric technologies on the market, which may include fingerprint biometric authentication (using fingerprint sensors), vein biometric authentication (using palm vein or finger vein sensors), to authenticate its users. It is worth underlining that the herein claimed matter does not approach technical and/or functional characteristics of these biometric sensors genres.

The system created by the financial institutions via information of physical characteristics of each user preferably uses three market biometric authentication technologies fingerprint biometric authentication (using fingerprint sensor), vein biometric authentication (using palm vein or finger vein sensors), considering that, this way, the usage and access to bank account of each user by ATM of the Company “X” will be performed with biometric technologies selected by each one of the financial institutions.

### BRIEF DESCRIPTION OF THE DRAWINGS

The “Multibank Biometric Authentication System Applied in Automatic Teller Machines Preferably with Three Biometric Sensors” will be comprehensively described with reference to drawings related below, where:

FIGS. 1 and 2 respectively illustrate schematic front and side views of the architecture of an ATM terminal, where only its main components and/or devices are indicated for informational purposes;

FIGS. 3, 4, 5, 6, 7 and 8 illustrate the message exchange diagrams performed between an ATM terminal and a financial institution to fetch the security device (biometric templates) that will be used to authenticate a user at the ATM terminal;

FIG. 9 illustrates the security diagram applied to the multi-bank and multi-biometrics biometrics solution;

FIG. 10 illustrates the ATM software architecture for biometric authentication;

FIG. 11 illustrates the treatment sequence when there is failure in the biometric authentication of a user at the ATM terminal;

FIGS. 12 and 13 illustrate the screens displayed at the ATM terminal at the time of the user biometry treatment for the biometric sensors fingerprint and finger vein (FIG. 12) and the palm vein sensor (FIG. 13);

FIG. 14 shows the complete user treatment sequence at the ATM terminal for biometric authentication with fingerprint, finger vein, or palm vein biometric sensors or other security devices (password, “TAN CODE” or “TOKEN”); and

FIG. 15 shows the physical installation of the fingerprint, finger vein, and palm vein biometric sensors connected to the USB port of the ATM CPU.

### DETAILED DESCRIPTION

According to the presented on drawings above displayed, on the System proposed by the Company “X”, the biometric information of Users “U” are required from the financial institution informing which biometric sensors are available to be used by its User “U” on the ATM terminal in use. The financial institution verifies the biometric sensors available on the ATM terminal and sends the corresponding biometric characteristics (biometric templates encrypted) for authentication of User “U” using the market biometric technology selected by the financial institution, being, for example, palm vein, finger vein or fingerprint, or even any other proper technology and performs the transaction via biometric authentication.

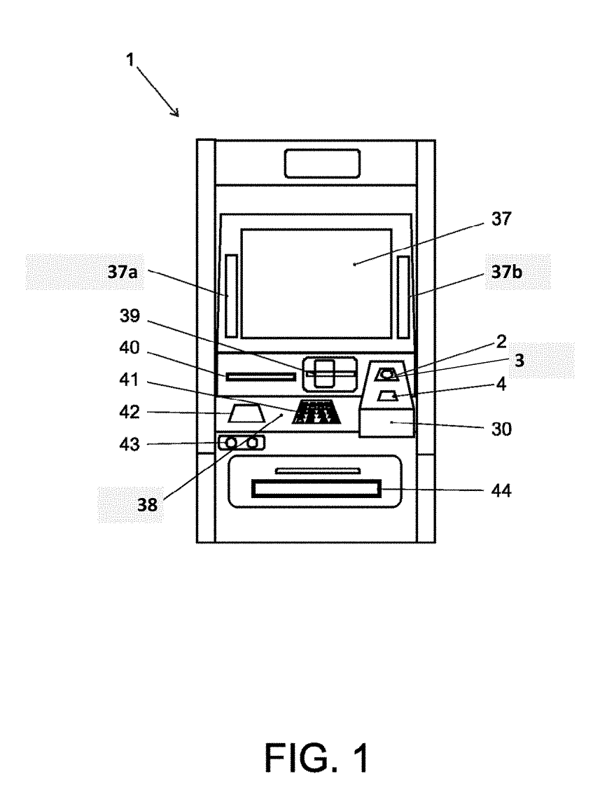

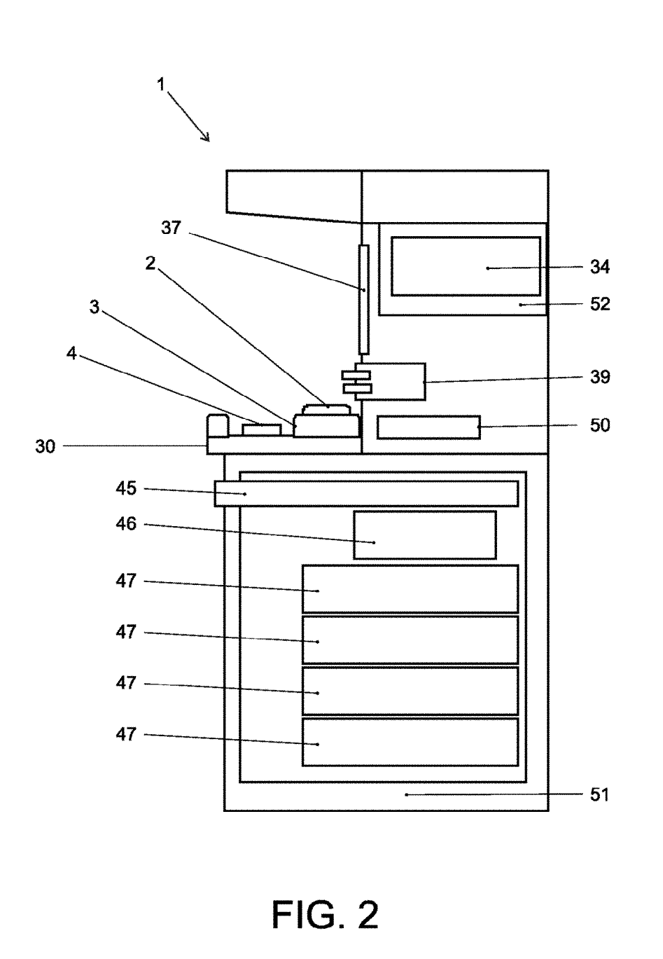

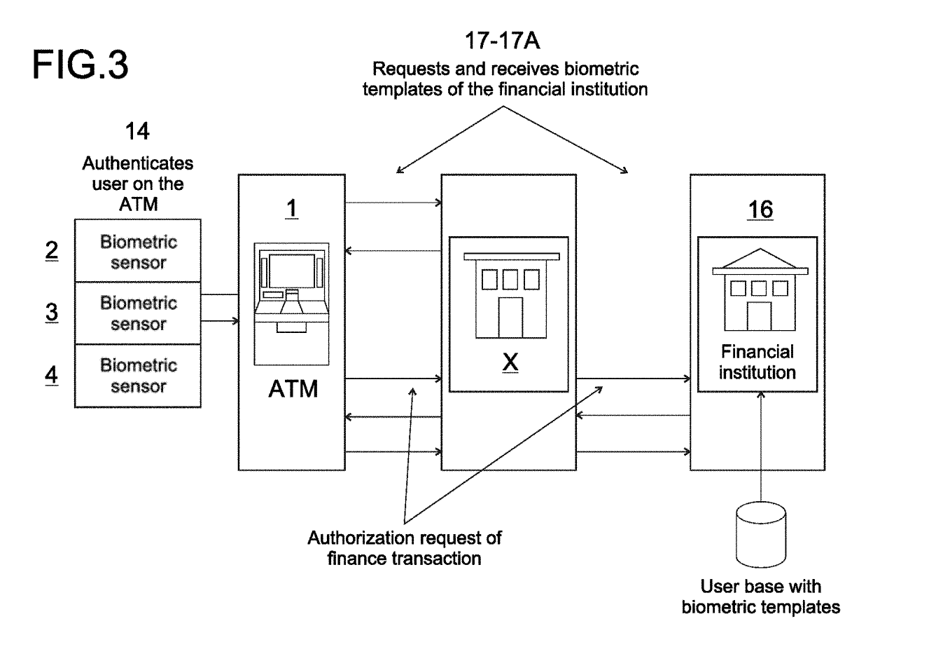

For purposes of information, FIGS. 1 and 2 describe the architecture of an ATM terminal 1, where items such as dual function keyboard 38 positioned on the sides of the LCD video terminal 37, DIP smart card reader 39, printer 40, keyboard Encrypting PIN Pad (“EPP”) 41, the contactless card reader 42, the headset-accessibility jack 43, the note/money dispenser 44, the protection CPU 52, the presenter 45, banknote rejection box 46, the note/money cassettes 47, printer 50 and the equipment cabinet (safe) 51.

Firstly, a biometric key is defined between the financial institution 16 and the Host of the Company “X” and a key for each ATM terminal between the Host of the Company “X” and ATM terminals, with this key being periodically changed.

The biometric encrypted template is an important identification of the User “U” and needs to be securely stored and transported by the biometric key defined between the financial institution 16 Host and Company “X”, being translated on the Host of Company “X” for the ATM key and, subsequently, submitted to the requesting ATM. Thus, a security architecture is defined for transporting the referred templates between the financial institution and software of biometric devices of ATM terminals from the Company “X” (as it may be understood by observing FIG. 2).

The Company “X” performs biometric authentications applied in market ATM 1, for Users “U” of financial institutions, through information of physical characteristics of each User “U” for preferably three market biometric authentication technologies being used, for example, fingerprint sensors 2, finger vein sensors 3, or palm vein sensors 4.

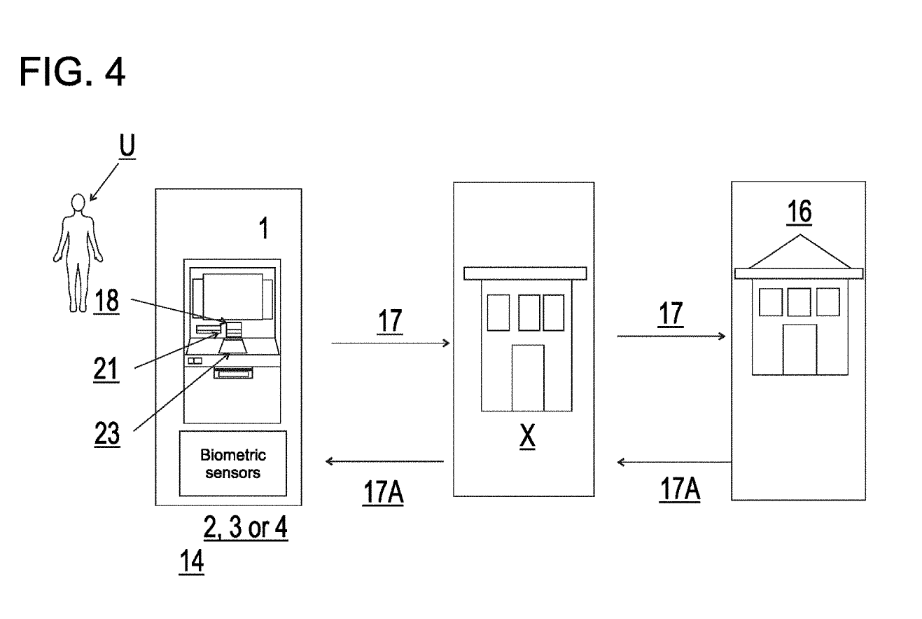

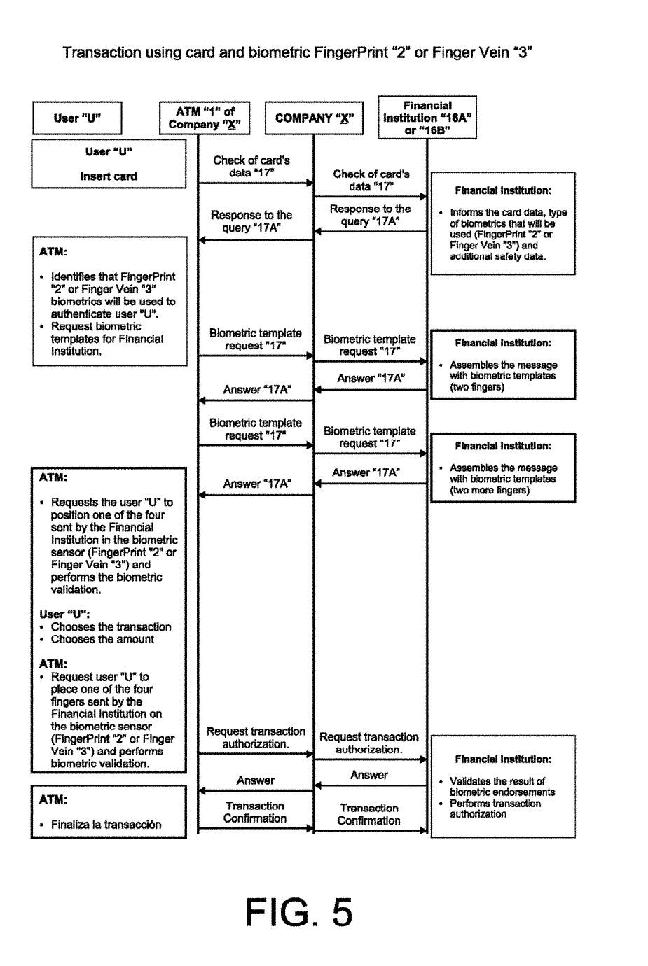

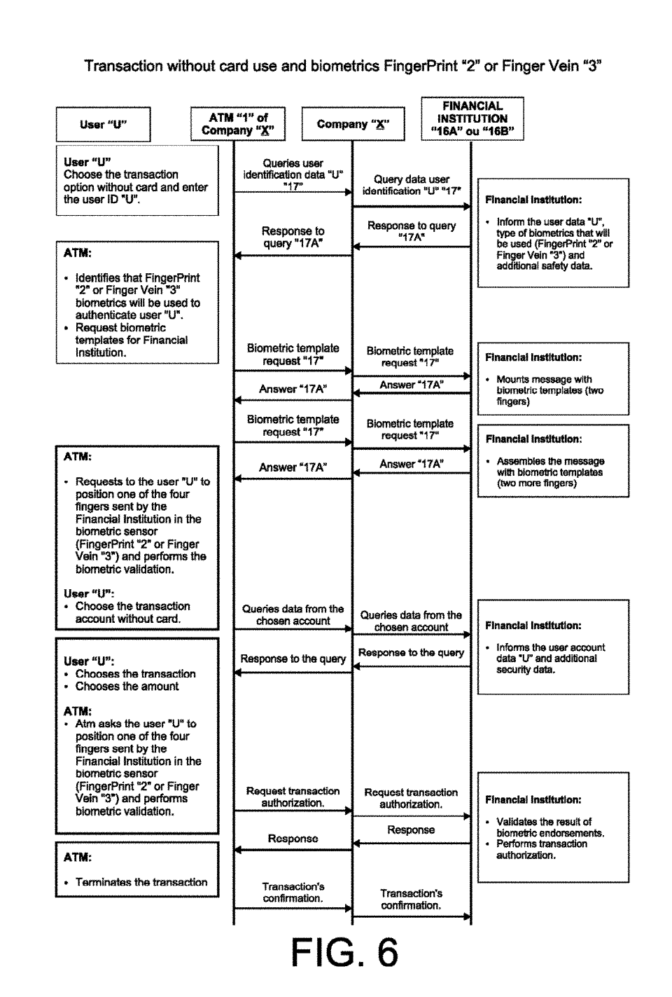

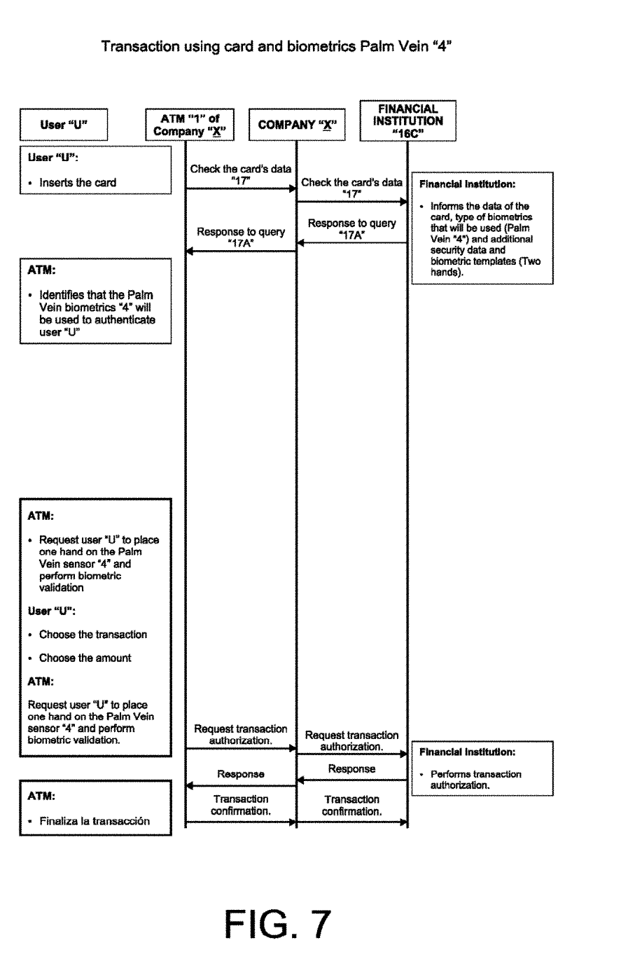

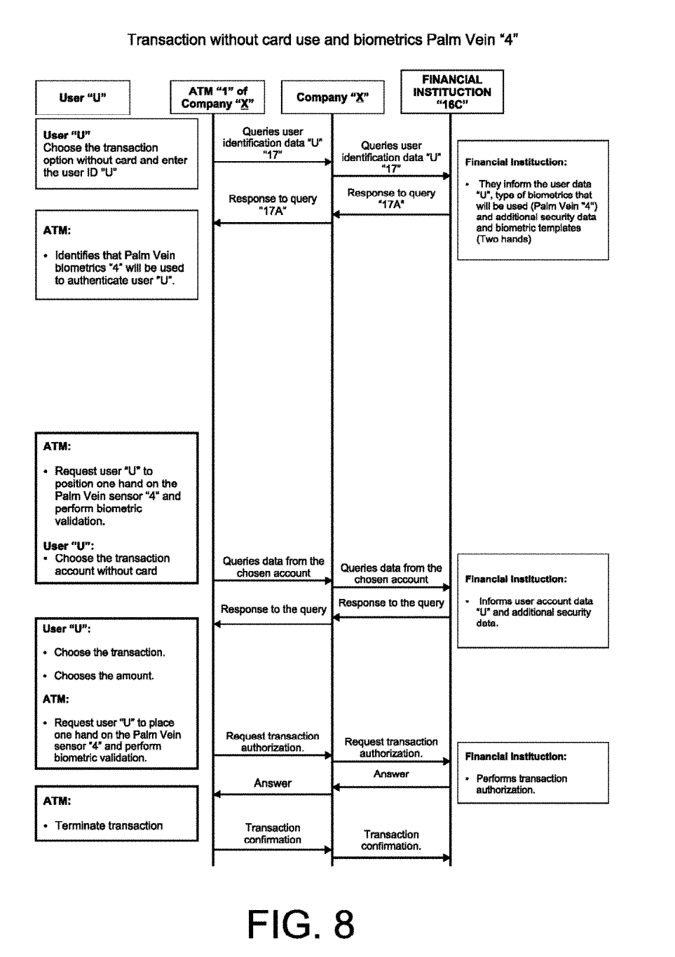

FIGS. 4, 5, 6, 7, 8, 9 and 14 illustrate the present system which allows transactions to be performed requesting only the biometric authentication with the market technology chosen by the financial institution (such as fingerprint 2, finger vein 3 or palm vein 4) and/or requesting contingency security mechanisms (Positive Identification Number (“PIN”), “TAN CODE” and “TOKEN”), or that are carried out requesting the combination of security devices and mechanisms, as an example: biometrics and password of the card; biometrics and “PIN”; biometrics, “PIN”, “TAN CODE” and/or “TOKEN”; no biometrics with card password, “PIN”, “TAN CODE” and “TOKEN”; or even biometrics.

The present system also enables transactions to be performed requesting only biometric authentication with the market technology selected by the financial institution (such as fingerprint 2, finger vein 3 or palm vein 4) and/or requesting contingency security mechanisms (“PIN”, “TAN CODE” and “TOKEN”), or even further, to be performed requesting the combination of security devices and mechanisms, i.e., as example: biometry and card password; biometry and “PIN”; biometry, “PIN”, “TAN CODE” and/or “TOKEN”; no biometry with card password, “PIN”, “TAN CODE” and “TOKEN”; or even further, only biometry. A “TAN CODE” is a transaction authentication number used in online banking as a one-way use of single passwords to authorize financial transactions. TANs are a second layer of security above and beyond traditional single-password authentication. A “TOKEN” is an electronic device that generates passwords, usually without physical connection to the computer, and in some versions it can also be connected to a USB port.

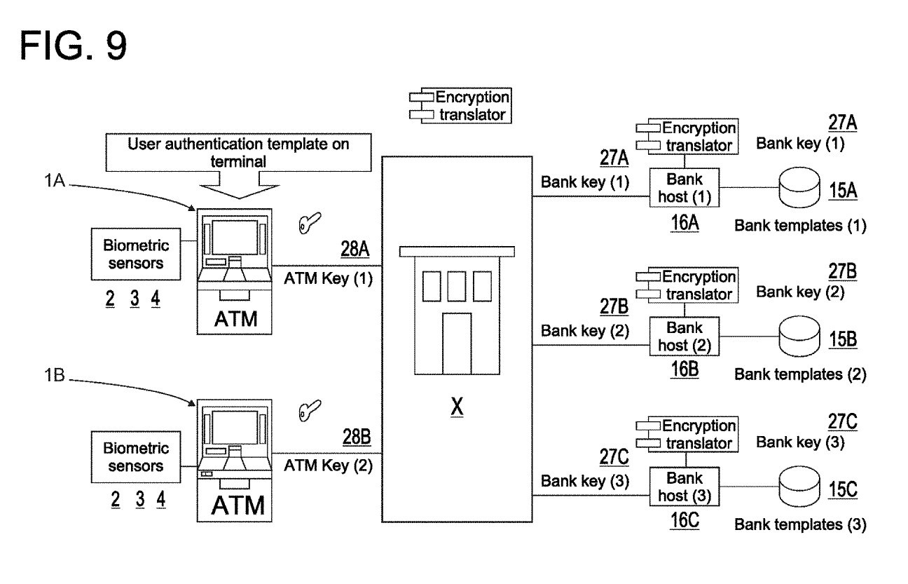

As seen in FIG. 9, the invention enables the financial institution (16A or 16B or 16C) to select security devices and/or biometric technology to be used on transaction authorization. Upon logging the User “U”, through its identification of which financial institution that the User “U” is linked, the ATM (1A or 1B) verifies the financial institution (16A or 16B or 16C) to search for information regarding which security devices will be used on transaction authorization. In this information query by security devices, the ATM (1A or 1B) submits information from biometric sensors that are present and available to be used (fingerprint 2, finger vein 3 and/or palm vein 4) during the transaction authorization of the User “U”. The financial institution (16A or 16B or 16C) verifies the biometric sensors available (sensors 2, 3 and/or 4) and one of the sensors corresponds to the biometric technology selected for the referred User “U” and retrieves the security information that will be used on transaction authentication (biometric technology selected by the financial institution (16A or 16B or 16C)).

The present invention also starts the transportation on security of personal characteristics. For transportation of personal characteristics (biometric templates 15A or 15B or 15C) of User “U”s, a biometric key (27A or 27B or 27C) between the financial institution (16A or 16B or 16C) and the Host of the Company “X”, and a key (28A or 28B) between the Host of the Company “X” and the ATM (1A or 1B) is defined, this key being periodically changed. Each financial institution (16A,16B or 16C) will perform the exchange of biometrics information through a specific encryption key and which can be dynamically exchanged with Company “X”. Company “X” will translate the template (15A, 15B or 15C) into the ATM terminal encryption key (28a or 28b). Company “X” will be responsible for the ATM terminal key. Each ATM terminal will have its encryption key and can be dynamically switched.

Regarding the security solution, the biometric template (15A or 15B or 15C) is an important identification of the User “U” and needs to be securely stored and transported by the biometric key (27A or 27B or 27C) defined between the Host of the Company “X” and the financial institution (16A or 16B or 16C). The template is then translated on the Host of the Company “X” for the key (28A or 28B) of the ATM (1A or 1B) and then submitted to the requesting ATM (1A or 1B). Thus, a security architecture is defined for transportation of the referred biometric templates (15A or 15B or 15C) between the financial institution (16A or 16B or 16C) and the ATMs (1A or 1B) of the Company “X”.

The present invention monitors one, two or three biometric sensors (2, 3 and/or 4) present on the ATM terminal 1. It enables to monitor which market biometric technologies (fingerprint 2, finger vein 3 and/or palm vein 4) are present on the ATM terminals (1A or 1B) and the respective states (present, operable, inoperable or disconnected sensor from the ATM CPU).

This invention provides a set of biometric sensors (2, 3 and/or 4) to perform biometric authentication 14 incorporated to an ATM terminal 1 to enable financial institutions to select security devices and biometric technology that will be used for transaction authorization of the User “U” on ATM terminal 1. The set of biometric sensors (2, 3 and/or 4) that enable biometric authentication 14 allow the ATM terminal 1 to search for registration information 17 and biometric templates 15 on the financial institution 16 indicating on the request message 17, the biometric technologies (biometric sensors 2, 3 and/or 4 installed), the respective types and states of biometric sensors (operable or not). The financial institution 16 verifies the type of biometric sensors (2, 3 and/or 4) installed on the ATM terminal 1 and selects security devices and/or the biometric technology for transaction authorization 14 of the User “U”.

In this moment, other security devices might be submitted by the financial institution 16 to be captured on the ATM 1, such as, for example, the card password, the positive identification number or access letter, the “TAN CODE” and the “TOKEN”.

Thus, the system is presented positively flexible and configurable for usage of security devices and/or biometric technologies (2, 3 and/or 4) in ATM terminals 1. The system enables financial institutions to select biometric technologies on the market (2, 3 and/or 4), and keep performing transactions on ATM terminals 1 of the Company “X” using the security devices and biometric technologies used in their networks. Examples: requesting only biometric authentication 14; transactions performed requesting contingency devices “PIN”, “TAN CODE” and “TOKEN”; transactions performed requesting the combination of following devices: biometry and card password; biometry and “PIN”; biometry, card identification, “TAN CODE” or “TOKEN”; no biometry with card password, “PIN”, “TAN CODE” and “TOKEN”, or only biometry.

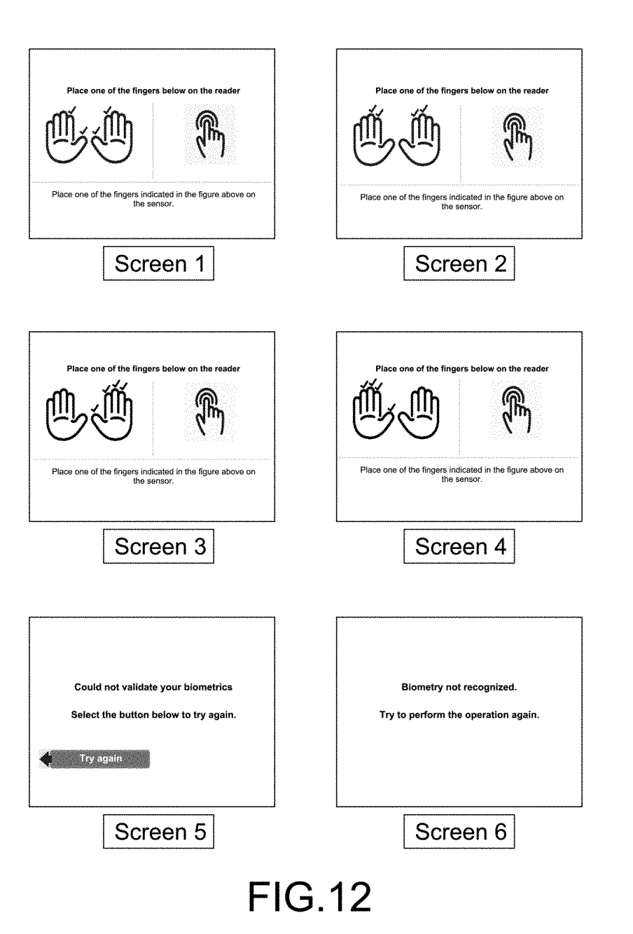

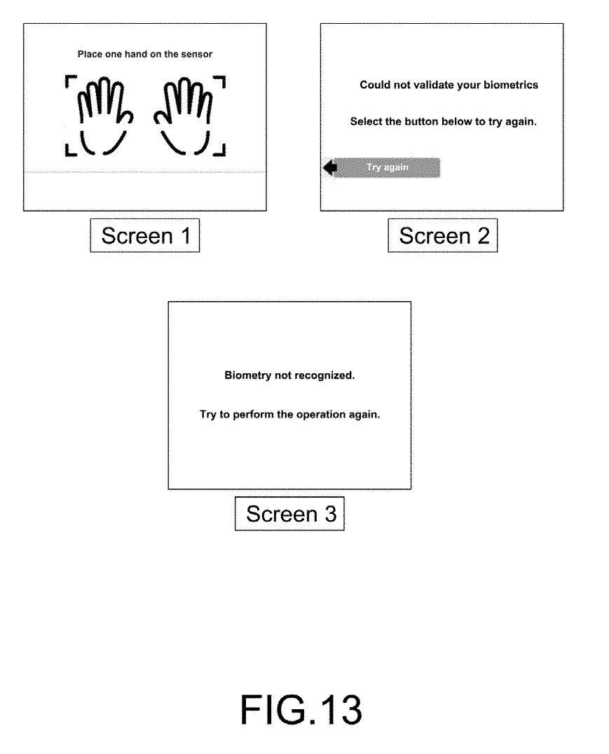

Regarding the macro validation sequence of the User “U” with biometric authentication, the User “U” initiates the session in the ATM—example: inserts the card to read the identification of the User “U” or the User “U” chooses transaction without card and type their identification 18; the ATM requests for financial institution 16 the registration information 17 of the User “U”; then ATM terminal 1 receives 17A the cadastral information (smart card treatment, biometrics and other security devices); then if the User “U” started the card session, the ATM performs validation 21 of the “CHIP Smart Card” of the User “U”; prompts User “U” to place finger (FIG. 12 screens 1, 2, 3 or 4) or palm (FIG. 13, screen 1) to perform biometric authentication 14 of User “U”; (FIG. 12 screens 1, 2, 3 or 4) or the palm of the hand (FIG. 13, screen 1) to perform the second biometric authentication 14 of User “U”; requests authorization and ends the transaction.

Screen 5 of FIG. 12 illustrates the screen displayed at the ATM terminal 1 when failure of biometric authentication of User “U” occurs when using fingerprint biometric sensor 2 or finger vein biometric sensor 3 of the ATM terminal 1.

Screen 6 of FIG. 12 illustrates the screen displayed at the ATM terminal 1 when it attempts to deplete biometric authentication of User “U” on fingerprint biometric sensor 2 or finger vein biometric sensor 3 from ATM terminal 1 and not allows to carry out the transaction with other security devices (password, “TAN CODE” or “TOKEN”).

Screen 1 of FIG. 13 illustrates the screen displayed at the ATM terminal 1 when requesting the User “U” to position the hand on the palm vein biometric sensor 4 of the ATM terminal 1.

Screen 2 of FIG. 13 illustrates the screen displayed at the ATM terminal 1 when the User “U” biometric authentication fails when using the palm vein biometric sensors 4 of the ATM terminal 1.

Screen 3 of FIG. 13 shows the screen displayed at the ATM terminal 1 when it exhausts the attempts of biometric authentication of User “U” in the biometric sensor palm vein 4 of ATM terminal 1.

Regarding the macro validation sequence of the User “U” with biometric authentication 14, the User “U” starts the session on the ATM 1, for example, User “U” inserts card 18 for magnetic stripe scanning; the ATM 1 requests to the financial institution 16 the registration information 17 of the User “U”; then the ATM 1 receives registration information 17A (smart card treatment, biometry and other security devices); subsequently, the ATM requests to insert card 18 and validates 21 the Smart Card CHIP of the User “U” card; requests the User “U” to position its finger or hand palm to perform the biometric authentication 14 of the User “U”; requests and captures the password 23 of the User “U”; requests the selection of transaction, value, requests authorization and complete the transaction.

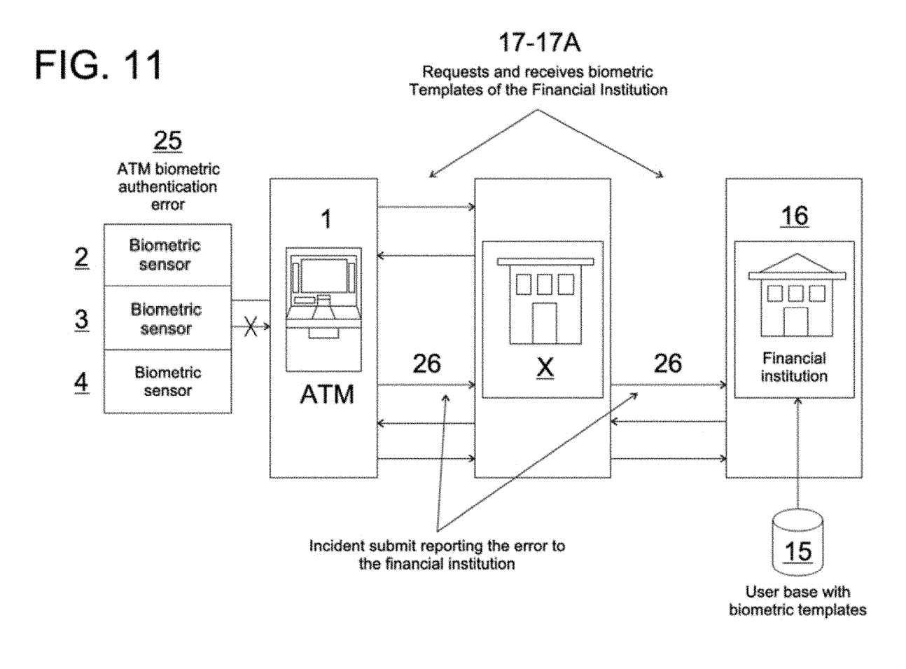

As seen in FIG. 11, regarding biometric errors 25 flagged on the user biometric authentication on ATM terminal 1, are provided errors on the biometric template 17A submitted by the financial institution 16; error on the User “U” authentication—different biometry from the registered on financial institution 16 (FIG. 12—screen 6 or FIG. 13—screen 3); biometry scanning timeout of the User “U” on ATM and cancellation requested by the User “U” while scanning biometry.

When one of these errors occur, the ATM submits incident 26 in real time to the financial institution 16.

Only for example purposes, the biometric treatment with finger or hand palm scanning error (FIG. 12 screen 5 or FIG. 13 screen 2) is mentioned, with the following procedures: biometric sensor 2, 3, or 4 is enabled for finger or hand palm scanning; requests the User “U” to position its finger (FIG. 12 screen 1, 2, 3 or 4) or hand for scanning; requests the User “U” not to move its finger or hand palm until the scan and authentication is completed (match execution); then, an error occurs while executing the Match—failed attempt of biometric authentication of the User “U”, unsuccessful finger or hand palm scanning [finger or hand scanned with template (right hand) and finger or hand scanned with template (left hand)].

With this incident, the amount of biometric scanning errors is flagged (FIG. 12 screen 5 or FIG. 13 screen 2). Then, the biometric sensor (2, 3 or 4) is once again enabled for finger or hand palm scanning; requests the User “U” to position its finger (FIG. 12 screens 1, 2, 3 or 4) or hand (FIG. 13 screen 1) for scanning again, reminding that the finger or hand selection for scanning will always be made by the User “U”; if there is a proper scan—requests the User “U” not to move its finger or hand palm until the match is completed (finger or hand palm authentication); error occurs when performing the match—error on the User “U” biometric authentication attempt, considering that the finger or hand palm scan was successfully performed and the authentication failed [finger or hand scanned with template sent by a financial entity].

When it occurs, the amount of biometric scan errors 25 is updated, the biometric sensor is enabled once again for finger or hand palm scanning, requesting the User “U” to position its finger (FIG. 12—screens 1, 2, 3 or 4) or hand (FIG. 13—screen 1) once again for scanning, being the finger or hand selection for scanning made by the User “U”.

It requests the User “U” not to move its finger or hand palm until scanning and the match (finger or hand palm authentication) are completed; new transaction completed with authentication error (after three attempts of biometric scanning—capture and authentication).

When the third error occurs, the referred incident 26 is submitted to flag the User “U” biometric authentication error. A screen (FIG. 12, screen 2 or FIG. 13, screen 3) is displayed to the User “U” reporting the error and an error incident is submitted to the financial institution.

The amount of biometric scanning errors is updated and the sensor becomes unavailable for this User “U”, considering that for the “unavailable sensor” incident some rules are provided, among which the cable disconnection of ATM CPU biometric sensor, i.e., the biometric sensor is monitored via “XFS” commands and the triggering of this sensor must disable the biometric sensor. The operation restart of the biometric sensor (2, 3 or 4) is performed only with operation tests (remote or local).

Moreover, it becomes unavailable as well when a number of consecutive biometric validation errors 25 occurs, i.e., the number of possible errors 25 is configured on the Host of the Company “X” and is submitted via communication network to the ATM terminal 1. Errors are counted whenever the biometric scanning error 25 occurs, regardless if it happened to one or several Users “U”. Each unsuccessful hand palm-scanning attempt is accounted as an error 25. When an OK scan occurs (capture and authentication OK), the amount of errors 25 returns to zero.

In cases of unavailable biometric sensors (2, 3 and/or 4), on the start of a transaction, the ATM 1 submits the information query message 17 to the financial institution 16 with the information that sensors (fingerprint 2, finger vein 3 and palm vein 4) are present, but inoperative for use.

The financial institution 16 might submit the answer of the information query request 17A with the security data currently used to validate the User “U”—IDPOS/TAN CODE/TOKEN. Transaction authorization will be performed as if the ATM terminal 1 did not have the biometric sensor (2, 3 or 4) installed.

Information of installed biometric sensors (2, 3 and/or 4), available and unavailable, is submitted by the ATM 1 system to monitoring systems of the Company “X”.

The information submitted on biometric sensors (2, 3 and/or 4) monitoring are: (1) The status of sensors installed on the ATM terminal 1 that are: sensor status: inexistent; operative; inoperative; or disconnected, and (2) The monitoring of sensors (2, 3 or 4) that is performed by the ATM 1 that scans statuses and submits it to ATM monitoring systems of the Company “X”.

Regarding transaction processing, it is worth underlining that transaction records reporting that biometric authentication 14 occurred on the ATM 1 and the transaction base storage of the Company “X” are processed and displayed in managerial reports.

The system starts operational functions (ATM supervisor), i.e., the operational functions that allow technicians of the Company “X” to diagnose and correct problems on biometric sensors (2, 3 and/or 4), local or remotely.

The system started operational functions, which are sensor error diagnostic, biometric sensor tests (2, 3 and/or 4) and synchronization of biometric keys (28A or 28B), where the sensor error diagnostic provides, in turn, the diagnostic function of the operator menu for biometric sensor error flagging and automatic call for execution of problem correction function (biometric sensor tests); and alteration of diagnostic function of operator menu to flag update error of biometric keys on ATM 1 and automatic call to force the update of keys (28A or 28B).

A second operational function provides biometric sensors tests (2, 3 and/or 4), performed by biometric data capture and validation execution.

And further yet, one last operational function consists on synchronization of biometric keys (28A or 28B) that forces the exchange of biometric keys with the server of the Company “X” and it can be performed automatically or by remote operation.

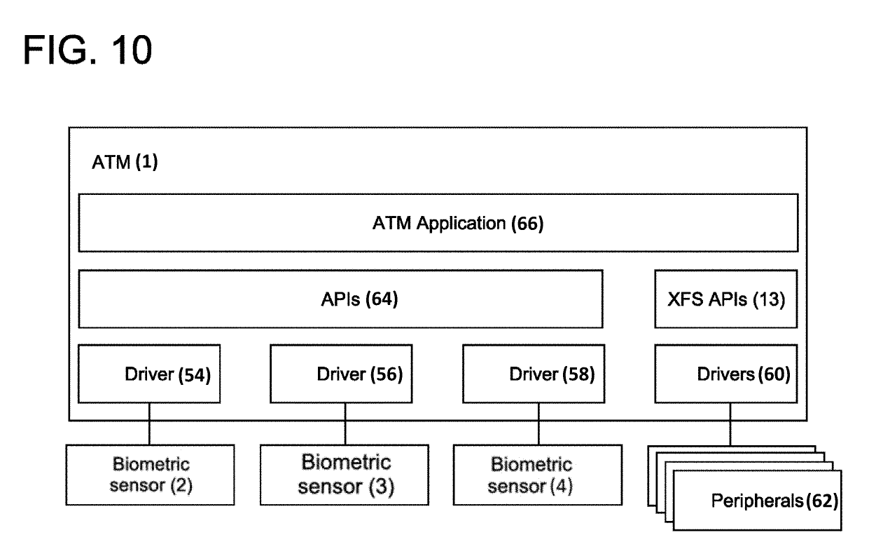

As seen in FIG. 10, the biometric sensors (2, 3 and 4) are connected to respective drivers 57, 56 and 58, which drivers are complemented by drivers 60 within the “architecture” of ATM 1, said drivers 54, 56 and 58 being subordinate to APIs 64, while the drivers 60 are subordinate to XFS APIs 13, and both APIs 64 and XFS APIs 13 are subordinate to ATM Application 66.

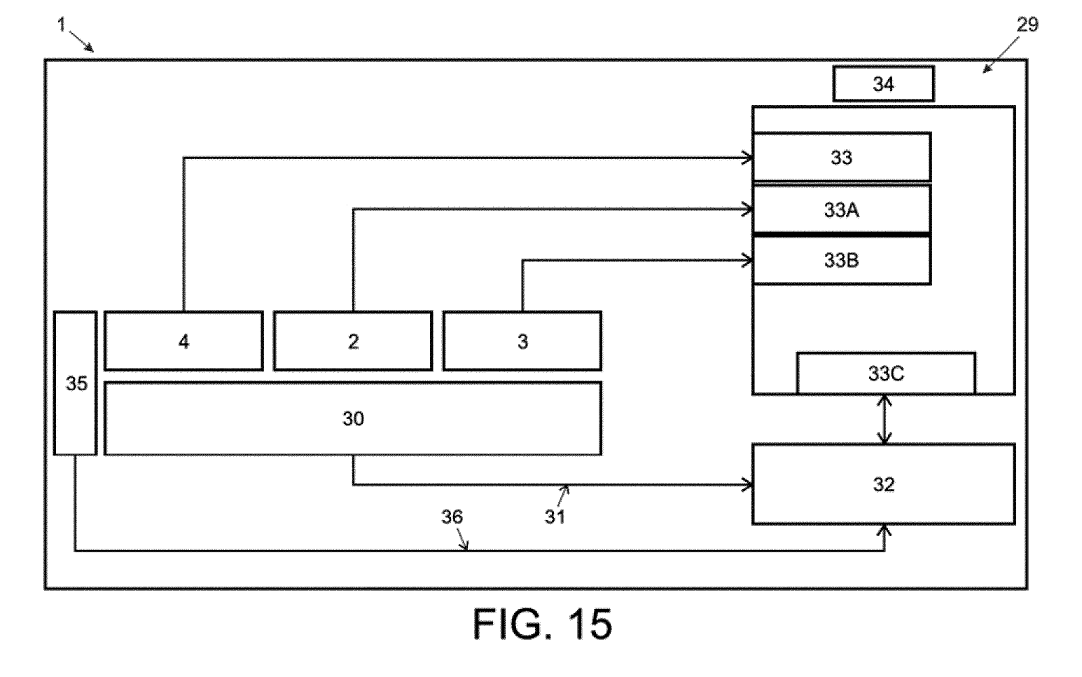

The diagram depicted in FIG. 15 illustrates the set of hardware devices 29 on which the present system operates, is housed in the ATM terminal 1 and includes the devices described below.

In FIG. 15 it can be seen that the fingerprint 2, finger vein 3 and palm vein 4 sensors are mounted on the sensor support 30, which sensor monitors 31 by its own safety sensor, its withdrawal from the ATM terminal 1. The sensor support 30 has a safety sensor to monitor the withdrawal of the sensor support 30 from the ATM terminal 1.

The sensor support 30 is connected to the ATM Security Card 32, the biometric sensors 2, 3 and 4 are in turn connected to the respective USB ports 33, 33A and 33B which are in turn connected to the CPU 34.

The CPU 34 also has another USB port 33C which, in turn, receives the connection from the ATM Security Card 32.

The ATM Security Card 32 further connects a set of LEDs 35 indicating 36 the positioning of the palm of the user's hand, which assembly is installed in the sensor holder 30 and is intended to guide the positioning of the palm of the User “U's” hand atop the palm vein 4 biometric sensor.

Finally, the fingerprint (2), finger vein (3) and palm vein (4) sensors are respectively connected to the USB ports 33, 33A and 33B positioned adjacent the CPU 34 of the ATM terminal 1.

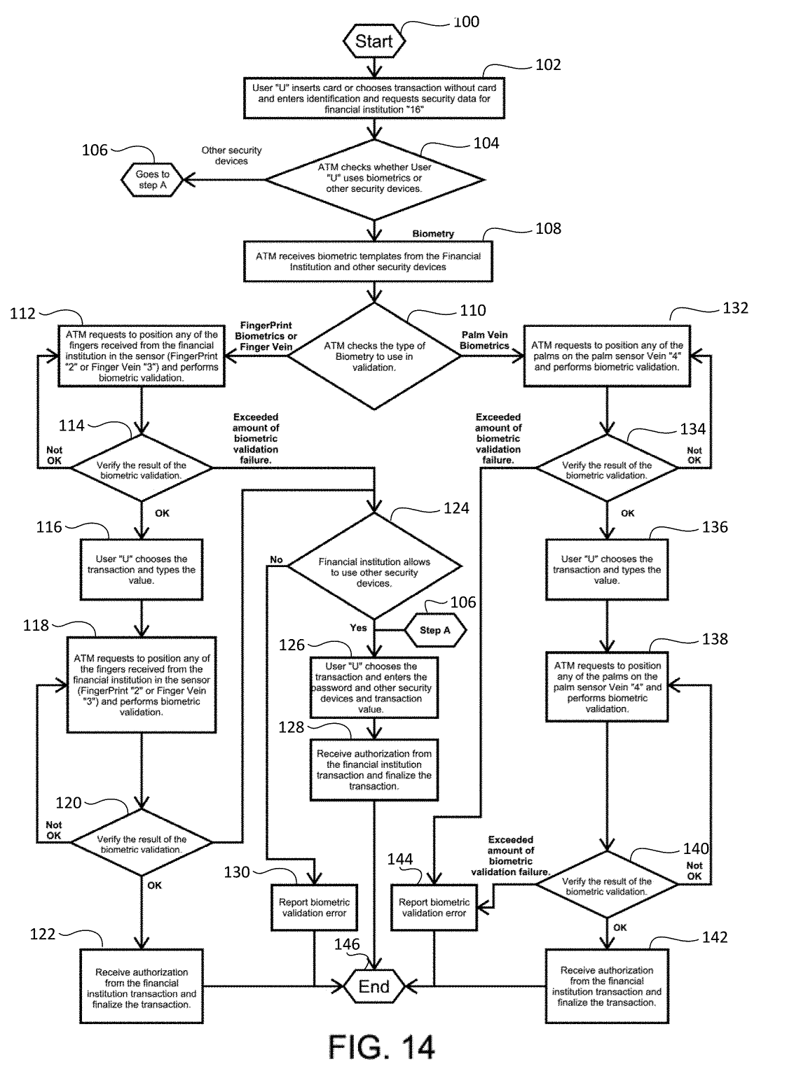

The method of biometric ATM authentication 14 applied in self-service terminals can be understood from the observation of FIG. 14, which illustrates the complete treatment sequence of User “U” at ATM terminal 1 for biometric authentication 14 with biometric sensors fingerprint 2 or finger vein 3 or palm vein 4 or other security devices.

Referring to FIG. 14, after the “start” indication 100, the first step 102 of the present method relating to the action of User “U”, which can insert card or choose transaction without card and enter the identification, requesting data from security for the financial institution 16; the second step 104, where the ATM 1 checks on whether User “U” uses biometrics or other security devices, and from the second step two paths can be taken, the first one if the answer is “other security devices”, proceed to step “A” 106, while the second of them, if the answer is “biometrics”, goes to the third step 108; the third step 108 comprises the reception by the ATM 1 of the biometric templates 15 of the financial institution 16 and other security devices, thus passing to the fourth step 110; the fourth step 110 comprises, on the part of ATM 1, the verification of the type of biometry that should be used in the validation 14, and from the fourth step 110 two paths can be taken, the first one if the option is by biometrics using fingerprint 2 or finger vein 3 is passed to the fifth step 112, while the second path is if the biometry is by palm vein 4, passing to the sixth step 132; the fifth step 112 comprises the ATM 1 requesting the User “U” to position any of the fingers received from the financial institution 16 on the fingerprint 2 or finger vein 3 sensor, thereby performing biometric validation 14; the sixth step 132 comprises that the ATM 1 prompts the User “U” to position either of the palms on the palm vein 4 sensor, thus performing the biometric validation 14 of the sixth step 132 and the seventh step 114, which comprises the verification of the result of the biometric validation 14 using the fingerprint 2 or finger vein 3 sensors, and from the seventh step 114 three paths can be taken, the first one if the answer is “not ok” determining the return to the fifth step 112, the second one way, if the answer is “ok”, it goes to the eighth step 116, where User “U” chooses the transaction and enters the value, the third path being determined when the amount of failure in the biometric validation 14 is exceeded it goes to the eleventh step 124 described below; from the sixth step 132 to the ninth step 134, which includes the verification of the biometric validation 14 result using the palm vein 4 sensor; of the ninth step 134 can be taken three ways, the first of them if the answer is “not ok”, determining the return to the sixth step 132, and the second path, if the answer is “ok”, is the tenth step 136, where the User “U” chooses the transaction and enters the value, the third path being determined when the amount of failure in the biometric validation 14 is exceeded; the eleventh step 124 is following the seventh step 114 and concerns the financial institution 16 to allow the use of other security devices, and from the eleventh step 124 two paths can be taken, the first one if the answer is “no” and then the twelfth step 130, which determines the error information in the biometric validation 14, while the second path, if the answer is “yes”, goes to step “A” 106 and to the thirteenth step 126, where User “U” chooses the transaction and enters the password and other security devices and the value of the transaction; of the eighth step 116, it is passed to the fourteenth step 118, which comprises the request, by the ATM 1, for User “U” to position any of the fingers received from financial institution 16 on fingerprint 2 or finger vein 3 sensor and perform biometric validation 14; from the tenth step 136 to the fifteenth step 138, which comprises the request, by the ATM 1, for User “U” to position any of the palms on the palm vein 4 sensor and perform the biometric validation 14; of the fifteenth step 138, it is passed to the sixteenth step 140, which comprises the verification of the result of the biometric validation 14 using the palm vein 4 sensor, and from the sixteenth step 140 can be taken two paths, the first of them, if the answer is “not ok”, and then to the twenty-first step 144, whereas in the second path, if the answer is “ok,” it is moved to the seventeenth step 142, which comprises that the ATM 1 receives authorization from the transaction of the financial institution 16 and finalize the transaction; the eighteenth step 128 follows the thirteenth step 126, this being the eighteenth step 128 corresponding to the reception, for part of the ATM 1, authorization of the transaction of the financial institution 16 and finalization of the transaction; the nineteenth step 120 follows from the fourteenth step 118, and this nineteenth step 120 comprises the verification of the result of the biometric validation 14, and from the nineteenth step 120 can be taken three paths, the first of them, if the answer is “not ok,” leading to the fourteenth step 118, while the second path, if the answer is “ok,” leads to the twentieth step 122, where the ATM 1 receives the transaction authorization from the financial institution 16 and ends the transaction, that the third path leads to the eleventh step 124; the twenty-first step 144 starts from the condition that the number of failures in biometric validation 14 has been exceeded after the ninth step 134, and the twenty-first step 144 refers to reporting error in the biometric validation 14 using the palm vein 4 sensor; the twelfth, seventeenth, twentieth and twenty-first steps 130, 142, 122 and 144, lead to the twenty-second step 146 of the present method of biometric authentication 14, applied to self-terminating terminals, twenty-second step 146 which corresponds to the end of this method.

Although the invention is detailed, it is important to understand that it does not limit its application to details and stages herein described. The invention is capable of other modalities and being practiced or executed in a variety of methods. It must be understood that the terminology herein applied is for description purposes and not for limitation.

1. “MULTIBANK BIOMETRIC AUTHENTICATION SYSTEM APPLIED IN AUTOMATIC TELLER MACHINES WITH BIOMETRIC SENSORS”, wherein the biometric authentication of users of multibank ATMs (1) is allowed by applying, preferably, three biometric sensors (2), (3) and (4); this system enables transactions to be performed on ATM (1), (1A) and (1B) requesting only biometric authentication or requesting contingency devices that include positive identification, TAN CODE and TOKEN, or even further, to be performed requesting the combination of biometry and card password devices; biometry and positive identification; biometry, positive identification, TAN CODE or TOKEN; no biometry with card password, positive identification, TAN CODE and TOKEN; or even further, only biometry, searching for biometric registration information of the user, on the financial institution (16A), (16B) and (16C), authenticating the user and authorizing the transaction by biometry.

2. “MULTIBANK BIOMETRIC AUTHENTICATION SYSTEM APPLIED IN AUTOMATIC TELLER MACHINES WITH BIOMETRIC SENSORS” according to claim 1, wherein the adoption of a biometric key (27A), (27B) and (27C) is provided between the financial institution (16A), (16B) and (16C) and the Host of a Company “X” and a key for each ATM (1A) and (1B) between the Host of the Company “X” and ATMs, this key being periodically changed; the encrypted biometric template (17A) is stored and transported by the biometric key defined between the financial institution Host (16A), (16B) and (16C) and the Company “X”, being translated on the Host of the Company “X” for the ATM key (28A) or (28B) and, subsequently, are submitted to the requesting ATM (1A) or (1B); use of biometric sensors (2), (3) and/or (4) on ATM (1); the system monitors the disconnection of the CPU sensor cable via alarm board of the ATM (1), considering that the sensor cable disconnection scanning is performed by running “SIU” command of the “XFS APIs” layer.

3. “MULTIBANK BIOMETRIC AUTHENTICATION SYSTEM APPLIED IN AUTOMATIC TELLER MACHINES WITH BIOMETRIC SENSORS” according to claim 1, wherein the registration information search (17) occurs by biometric templates (15A), (15B) or (15C) on the financial institution (16A), (16B) or (16C); the ATM (1A) or (1B) requests (17) to the financial institution (16A), (16B) or (16C), the user (U) registration information reporting that the ATM (1A) or (1B) has biometric sensors (2), (3) and (4) installed and the respective types and manufacturers; the financial institution (16A), (16B) or (16C) validates types and manufacturers of sensors (2), (3) and (4) installed on the ATM (1A) or (1B) verify if the user (U) has biometry registered and submits (17a) biometric templates (15A), (15B) or (15C) corresponding to financial institution definition (16A), (16B) or (16C) and registered in its biometric template base (15A), (15B) or (15C).

4. “MULTIBANK BIOMETRIC AUTHENTICATION SYSTEM APPLIED IN AUTOMATIC TELLER MACHINES WITH BIOMETRIC SENSORS” according to claim 1, wherein other financial institutions (16A), (16B) or (16C) allow to use other security devices to be captured on the ATM (1A) or (1B), such as, for example, card password, positive identification or access letter, TAN CODE and TOKEN.

5. “MULTIBANK BIOMETRIC AUTHENTICATION SYSTEM APPLIED IN AUTOMATIC TELLER MACHINES WITH BIOMETRIC SENSORS” according to claim 1, wherein regarding the user (U) authentication, the ATM activates the sensor (2), (3) or (4) corresponding to templates (17A) submitted by the financial institution (16A), (16B) or (16C), these sensors can be of palm vein (2), finger vein (3) or fingerprint (4) types and requests the user (U) to position its finger or hand palm on the sensor and perform biometric authentication (14); the transaction authorization with biometry occurs in such a way that upon authorization request of the financial transaction is informed that there was a biometric authentication of this user (U) and it was submitted to authorization, the other security devices requested upon consultation; the biometric authentication must respect some conditions or rules so it may occur on a proper manner, considering that, the user (U) has a given number “X” of attempts to scan and perform biometric authentication, where “X” is a authentication attempt parameter configured on the Host of the Company “X”.

6. “MULTIBANK BIOMETRIC AUTHENTICATION SYSTEM APPLIED IN AUTOMATIC TELLER MACHINES WITH BIOMETRIC SENSORS” according to claim 1, wherein it is provided that the first rule covers the scanning and authentication times: the amount of attempts and the time for scanning and authentication are configurable; the ATM (1A) or (1B) cancels the attempt of biometry scan of the user (U) after a number “Y” of seconds configured on the Host of the Company “X” waiting for positioning of finger or hand palm; this ATM (1A) or (1B) flags the user (U) delay error and returns to section start to wait a new card insertion; then, the ATM (1A) or (1B) cancels the scan and authentication attempts of the user (U) after three hand palm authentication errors.

7. “MULTIBANK BIOMETRIC AUTHENTICATION SYSTEM APPLIED IN AUTOMATIC TELLER MACHINES WITH BIOMETRIC SENSORS” according to claim 1, wherein regarding the macro validation sequence of the user (U) with biometric authentication, the user (U) inserts the card (18) for magnetic stripe scanning; the ATM (1A) or (1B) requests to the financial institution (16A), (16B) or (16C) the registration information of the user (U); then the ATM receives registration information (17A), smart card treatment, biometry and other security devices; subsequently, the ATM requests to insert card (18) and validates (21) the Smart Card CHIP of the user (U) card; requests the user (U) to position its finger or hand palm to perform the biometric authentication (14) of the user (U); requests and captures the password (23) of the user (U); requests the selection of transaction, value, requests authorization and complete the transaction.

8. “MULTIBANK BIOMETRIC AUTHENTICATION SYSTEM APPLIED IN AUTOMATIC TELLER MACHINES WITH BIOMETRIC SENSORS” according to claim 1, wherein regarding the errors (25) flagged on the user (U) biometric authentication on the ATM (1), it is able to predict template (17A) errors submitted by the financial institution (16); error on the user (U) authentication—different biometry from the registered one on the financial institution (16); biometry scanning timeout of the user (U) on the ATM (1) and cancellation requested by the user (U) while scanning biometry, considering that when one of these errors occur, the ATM submits incident (26) in real time to the financial institution (16); the amount of biometric scan errors is flagged and the biometric sensor is once again enabled for hand palm scanning; requests the user (U)—to position its hand once again for scanning; if the scanning is OK¬requests the user (U) not to move its hand palm until the match is completed, which is the hand palm authentication; an error occurs when performing the match—error on the user (U) biometric authentication attempt, considering that the hand palm scan was successfully performed and the authentication failed, on cases of hand palm scanned with templates (17a); when it occurs, the amount of biometric scan errors is updated, the biometric sensor is enabled once again for hand palm scanning, requesting the user (U) to position its hand once again for scanning, then it requests the user (U) not to move its hand palm until scanning and hand palm authentication are completed; finally, when the third error occurs, this incident (26) in submitted to flag the user (U) biometric authentication failure and the problem reason is created to flag the problem.

9. “MULTIBANK BIOMETRIC AUTHENTICATION SYSTEM APPLIED IN AUTOMATIC TELLER MACHINES WITH BIOMETRIC SENSORS” according to claim 1, wherein after a given number “X” of biometric scan errors, the sensor becomes unavailable for this user (U), considering that for the “Unavailable sensor” incident some rules are provided, among which the cable disconnection of ATM CPU; the operation restart of the biometric sensor is performed only with operation tests (remote or local); it is indispensable as well when there is a number of biometric validation consecutive errors, where the maximum errors possible is configured on the Host of the Company “X” and is submitted via communication network to ATM; amount of consecutive errors of biometric scan that exceed the error threshold value configured on the capture point configurator; errors are counted whenever the biometric scanning error occurs, regardless if it happened to one or several users (U); each unsuccessful hand palm scanning attempt is accounted as error; on first scan with proper capture and authentication, the amount of errors returns to zero; in cases of unavailable biometric sensors, on the start of a transaction, the ATM submits the information query message (17) to the financial institution (16) with the information that sensors palm vein (2), finger vein (3) and fingerprint (4) are present, but inoperative for use; thus, the financial institution (16) might submit the answer of the information query request (17A) with the security data currently used to validate the user (U)—IDPOS/TAN CODE/TOKEN; and the transaction authorization will be granted as if the ATM had no biometric sensor (2), (3) or (4) installed.

10. “MULTIBANK BIOMETRIC AUTHENTICATION SYSTEM APPLIED IN AUTOMATIC TELLER MACHINES WITH BIOMETRIC SENSORS” according to claim 1, wherein the information of available and unavailable sensors are submitted by the ATM (1) monitoring agent, software installed on ATM that monitors equipment peripherals, for monitoring systems of the Company “X”, considering that the information, which are submitted on TRAP biometric sensor monitoring are: the status of sensors installed on the ATM that, in turn, are palm vein: sensor status: inexistent; operative; inoperative; or disconnected. the sensor status: returns from BIOAPIs; SDK version; the finger vein: sensor status: inexistent; operative; inoperative; or disconnected; the sensor status: returns from BIOAPIs; SDK version: fingerprint: sensor status: inexistent; operative; inoperative; or disconnected; sensor status: returns from BIOAPIs; SDK version; and the sensor monitoring that is performed by the “ATM monitoring agent”, which is the software installed on the ATM that scans statuses and submits to ATM monitoring systems, and statuses are submitted via TRAPs for monitoring systems, i.e., SNMP protocol.

11. “MULTIBANK BIOMETRIC AUTHENTICATION SYSTEM APPLIED IN AUTOMATIC TELLER MACHINES WITH BIOMETRIC SENSORS” according to claim 1, wherein regarding the transaction processing, transaction records reporting that biometric authentication occurred on the ATM and the transaction base storage of the Company “X” and on the financial institutions (16) are processed and displayed in managerial reports.

12. “MULTIBANK BIOMETRIC AUTHENTICATION SYSTEM APPLIED IN AUTOMATIC TELLER MACHINES WITH BIOMETRIC SENSORS” according to claim 1, wherein regarding the security solution, the biometric template (17A) is transported by a security architecture for transportation of templates between financial institutions and the ATMs of the Company “X”, where this architecture is resumed in a biometric key (27A), (27B) and (27C) defined between the financial institution (16A), (16B) e (16C) and Host of the Company “X” and a key (28A) and (28B) for each ATM between the Host of the Company “X” and ATMs (1A) and (1B), considering that the ATM biometric key (28A) e (28B) must be periodically changed; financial institutions (16A), (16B) and (16C) submit encrypted templates (17A) by the biometric key (27A), (27B) or (27C) defined between the Host of financial institution (16A), (16B) or (16C) and the Company “X” and the templates encrypted by the Company-bank key are translated into the Host of Company “X” for the ATM key (28A) or (28B), considering that templates (15A), (15B) or (15C) translated for templates with ATM key (28A) or (28B) are submitted by Host of the Company “X” for the ATM (1A) or (1B) that requested the templates (17).

13. “MULTIBANK BIOMETRIC AUTHENTICATION SYSTEM APPLIED IN AUTOMATIC TELLER MACHINES WITH BIOMETRIC SENSORS” according to claim 1, wherein a solution is provided for operational functions that enable technicians of the Company “X” to diagnose and correct problems on biometric sensors; said operational functions comprise the sensor error diagnostic, biometric sensor tests and synchronization of biometric keys, where the sensor error diagnostic, provides in its turn, the diagnostic function of operator menu for flagging the biometric sensor error and automatic call for execution of problem correction function; and the alteration of diagnostic function of operator menu to flag update error of biometric keys on ATM and automatic call to force the update of keys (28A) or (28B); a second operational function are the biometric sensors tests, which are performed by biometric data capture of finger or hand palm image of the Operator/Technician and validation execution; the biometric sensor validation test can only be performed locally; unable to perform validation remotely; and even further, one last operational function is the synchronization of biometric keys that forces the exchange of biometric keys with the server of the Company “X” and it can be performed automatically or by remote operation or with the presence of the operator on the ATM running the operational function of key synchronism.
